(19) United States
(12) Patent Application Publication
(10) Pub. No.: US 2010/0282664 A1
(43) Pub. Date: Nov. 11, 2010

(54) DEVICE FOR DEWATERING OF PULP

(76) Inventor: Jonas Avidson, Skoghall (SE)

Correspondence Address: NIXON & VANDERHYE, PC, 901 NORTH GLEBE ROAD, 11TH FLOOR, ARLINGTON, VA, 22203, US

(21) Appl. No.: 12/679,100

(22) PCT Filed: Sep. 15, 2008
(86) PCT No.: PCT/SE08/51030

§ 371 Date: Aug. 2, 2010

(30) Foreign Application Priority Data
Sep. 19, 2007 (SE) 0702089-4

(51) Int. Cl. B01D 33/067

(52) U.S. Cl. 210/402

(57) ABSTRACT

A dewatering drum for dewatering of cellulose pulp has two end plates, which are arranged at either end of the dewatering drum. The dewatering drum further has a support pipe, which has the shape of a cylindrical sleeve having a material thickness of at least 15 mm, and which, at its respective ends, is connected to the end plates. A liquid-permeable layer is arranged on the outside of the support pipe and is held in position at a distance from the outer periphery of the support pipe by means of spacer elements. The support pipe is provided along its periphery with at least ten openings through which liquid that passes through the liquid-permeable layer is able to penetrate into the interior of the support pipe.

### FIELD OF THE INVENTION

The present invention relates to a dewatering drum for dewatering of cellulose pulp, said dewatering drum having two end plates, which are arranged at either end of the dewatering drum, which along its outer periphery has a liquid-permeable layer, such as a screen plate or a filter net, against which cellulose pulp can be compressed for dewatering thereof, each of the end plates supporting at its central portion a first part of a shaft-bearing arrangement.

### BACKGROUND ART

When dewatering a suspension of pulp, in particular a suspension of cellulose pulp, use is often made of a dewatering drum. Generally, the dewatering drum has a filter net or a screen plate on the outside thereof, against which the pulp is compressed in a gap formed between a trough and the dewatering drum. The water that is pressed out of the pulp passes through the filter net or the screen plate and into longitudinal ducts that are formed on the outside of a central cylinder in the dewatering drum. The water is then conducted out of the drum, in parallel with the longitudinal axis of the drum, for further treatment. Generally, a washing step is also included in which water is poured over the partly dewatered pulp for the purpose of removing impurities from the pulp.

An example of a device of this kind for dewatering of cellulose pulp is disclosed in U.S. Pat. No. 6,311,849. The device disclosed in U.S. Pat. No. 6,311,849 has two parallel, counter-rotating dewatering drums. Wet pulp is supplied in the lower portion of each drum and is then conducted towards a central nip while being compressed between the respective drum and a trough. The liquid is removed in the axial direction in ducts, as illustrated, for example, in FIG. 3 of U.S. Pat. No. 6,311,849.

A disadvantage of the type of dewatering drum disclosed in U.S. Pat. No. 6,311,849 is that sometimes it may be difficult to remove the water from the drum rapidly enough. This is inconvenient since it is important, in particular at the end of the dewatering process, when the pulp is relatively dry, that the water that has been pressed out be drawn off from the surface of the screen plate that is in contact with the pulp.

### SUMMARY OF THE INVENTION

An object of the present invention is to provide a dewatering drum for dewatering of pulp, which dewatering drum has high capacity for receiving water that has been pressed out of the pulp.

This object is achieved by a dewatering drum as described by way of introduction and which is characterised in that the dewatering drum further comprises a support pipe, which has the shape of a cylindrical sleeve having a material thickness of at least 15 mm, and which at its ends is connected to the end plates, said liquid-permeable layer being arranged on the outside of the support pipe and held in position at a distance from the outer periphery of the support pipe by means of spacer elements, the support pipe being provided along its periphery with at least ten openings through which liquid that passes through the liquid-permeable layer is able to penetrate into the interior of the support pipe.

An advantage of this dewatering drum is that it has a high capacity for receiving water that is pressed out of the pulp and also, owing to the support pipe, great mechanical strength, which means that the pulp can be subjected to high pressures and, thus, be dewatered so as to obtain a high dry content. The great mechanical strength of the support pipe makes it possible to utilize a comparably weak, as seen from a mechanical point of view, liquid-permeable layer, having a high liquid permeability. Another advantage is that the water that has been pressed out of the pulp can rapidly leave the liquid-permeable layer, so that the pulp is not rewetted by the water.

According to one embodiment, the support pipe has at least one opening which allows liquid that has penetrated into the interior of the support pipe to be let out. One advantage of this embodiment is that liquid that has penetrated into the support pipe may also leave said pipe through openings in the support pipe itself. Thus, it is not necessary to provide recesses in the end plates to drain water off from the dewatering drum.

According to one embodiment, the dewatering drum has a portion along its length which is arranged to receive compressed cellulose pulp, at least one of said openings being arranged axially outside said portion. One advantage of this embodiment is that liquid may be efficiently transported out of the drum adjacent the area against which the pulp is compressed.

According to a preferred embodiment, the support pipe is substantially without inner structures. One advantage of this embodiment is that the drum is able to receive large quantities of liquid and that the risk of foaming inside the drum is reduced. A dewatering drum with a support pipe that is substantially without inner structures will also be easy to manufacture and maintain.

According to a preferred embodiment, the dewatering drum is arranged to rotate about a central shaft, which supports a separating wall, which is arranged to collect liquid that is pressed into the dewatering drum. One advantage of this embodiment is that liquids that are pressed into the dewatering drum at different position may be kept separate from one another. Another advantage is that liquid that is pressed into the upper portion of the drum may be prevented from making contact with the lower portion of the drum and, thus, from wetting the pulp located on the exterior of the drum's lower portion. The separating wall suitably extends from the shaft towards the support pipe, the shaft being arranged to receive liquid that has penetrated through the openings in the support pipe and to conduct the liquid out of the support pipe via the bearing arrangement.

Suitably, the support pipe is made of metal and has a material thickness in the range 15-50 mm. One advantage of this embodiment is that the support pipe will have satisfactory mechanical strength, despite the openings formed in the support pipe, without being too heavy.

According to a preferred embodiment, each of said at least ten openings in the support pipe has an open area in the range 1-200 cm². One advantage of this embodiment is that the risk of the openings being clogged is small, without this reducing the mechanical strength of the support pipe to any considerable extent. In a yet more preferred embodiment, each of the openings has an open area in the range 1.5-100 cm².

Suitably, the total open area of all openings in the support pipe corresponds to at least 10% of the inner lateral area of the support pipe. One advantage of this open area is that it allows rapid transport of relatively large quantities of liquid into the interior of the support pipe.

Further objects and characteristics of the present invention will be apparent from the description and the claims.

### BRIEF DESCRIPTION OF THE DRAWINGS

The invention will now be described in more detail, reference being made to the accompanying drawings.

FIG. 1 is a schematic cross-sectional view which illustrates a first embodiment of a device for dewatering of cellulose pulp.

FIG. 2 is a cross-sectional view which illustrates a dewatering drum shown in FIG. 1 along section II-II.

FIG. 3 is an enlarged cross-sectional view which illustrates a portion III of the dewatering drum shown in FIG. 2.

FIG. 4 is a three-dimensional, cross-sectional view which illustrates the dewatering drum shown in FIG. 1 along section IV-IV.

FIG. 5 is a schematic cross-sectional view which illustrates a second embodiment of a device for dewatering of cellulose pulp.

FIG. 6 is a three-dimensional, cross-sectional view which illustrates the dewatering drum shown in FIG. 5 along section VI-VI.

FIG. 7 is a schematic cross-sectional view which illustrates a third embodiment of a device for dewatering of cellulose pulp.

FIG. 8 is a three-dimensional, cross-sectional view which illustrates a dewatering drum shown in FIG. 7 along section VIII-VIII.

FIG. 9 is a cross-sectional view which illustrates an alternative dewatering drum for use, for example, in the device shown in FIG. 7.

FIG. 10 is a cross-sectional view which illustrates a further alternative dewatering drum for use, for example, in the device shown in FIG. 7.

### DESCRIPTION OF PREFERRED EMBODIMENTS

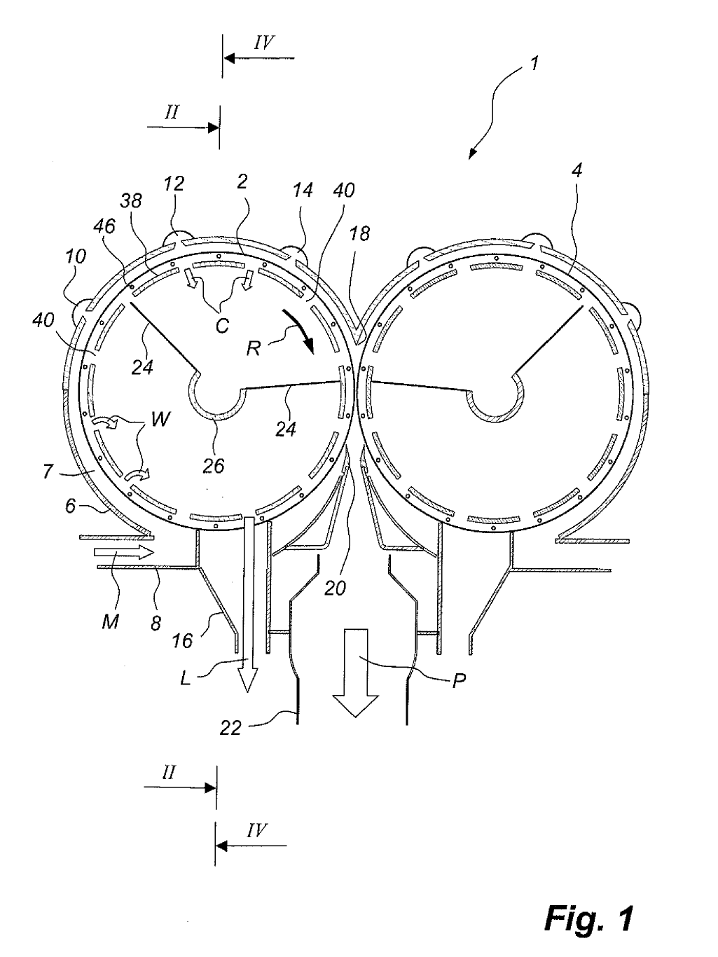

FIG. 1 illustrates, as seen from the side and in cross section, a device 1 for dewatering of wet cellulose pulp. The device 1 has a first dewatering drum 2 and a second dewatering drum 4. The dewatering drum 2 is arranged to rotate clockwise, as indicated by an arrow R in FIG. 1. The dewatering drum 4 is arranged to rotate in the opposite direction, i.e. counter-clockwise, but is, for the rest, similar in parts and function to the first dewatering drum 2, even if the second dewatering drum 4 is mirror-inverted relative to the first dewatering drum 2, and therefore the second dewatering drum 4 will not be described in more detail here.

The device 1 further comprises a trough 6 inside which the first dewatering drum 2 is arranged for rotation. At its lower portion the trough 6 has an inlet 8 for wet cellulose pulp, i.e. cellulose pulp with a dry content typically in the range 3-15% by weight TS. The trough 6 is provided with three liquid inlets 10, 12, 14 through which wash water may be supplied to the pulp. The trough 6 surrounds the drum 2 along about 240° of the circumference of the drum 2.

During dewatering of pulp the wet pulp is fed to the trough 6 via the inlet 8, as indicated by an arrow M, and is then compressed in the gap 7 formed between the trough 6 and the drum 2. The water contained in the pulp is pressed through the periphery of the drum 2 and into the interior of the drum 2, as indicated by arrows W in FIG. 1. The water pressed inside will accumulate at the bottom of the drum 2 and flow out therefrom, through the periphery of the drum 2, via a drainage channel 16, as indicated by an arrow L.

When the pulp has been sufficiently dewatered it leaves the trough 6 at the point 18 shown in FIG. 1 and is then compressed against the pulp that has been dewatered in a corresponding manner on the second dewatering drum 4. A scraper 20 is arranged to scrape off the dewatered cellulose pulp, which may typically have a dry content of 25-40% by weight TS, from the drum 2, whereby the dewatered pulp falls down into a pit 22 and leaves the device 1, as indicated by an arrow P.

To increase the purity of the dewatered pulp, wash water may be supplied through the inlets 10, 12, 14. This means that the wash water passes through the pulp, carries impurities with it and penetrates into the interior of the drum 2, as illustrated by arrows C. Inside the drum 2, a separating wall 24 has been arranged which collects the wash water and keeps it separated from the water pressed out of the pulp in the part of the trough 6 located closest to the inlet 8. The wash water collected by the separating wall 24 is then conducted via a fixed longitudinal shaft 26, which also acts as the shaft journal about which the drum 2 rotates, out of the drum 2, as will be described in more detail below.

The drum 2 has the advantage of allowing large quantities of water to be efficiently pressed out of the pulp, and into the interior of the drum 2, and also of allowing said water to be drained off in an efficient manner from the interior of the drum 2 and to leave the device 1 through a drainage channel 16. The drum 2 also makes it possible to separate the wash water, by means of the separating wall 24, from the water that is first pressed out of the pulp and that usually contains a larger amount of impurities than the wash water.

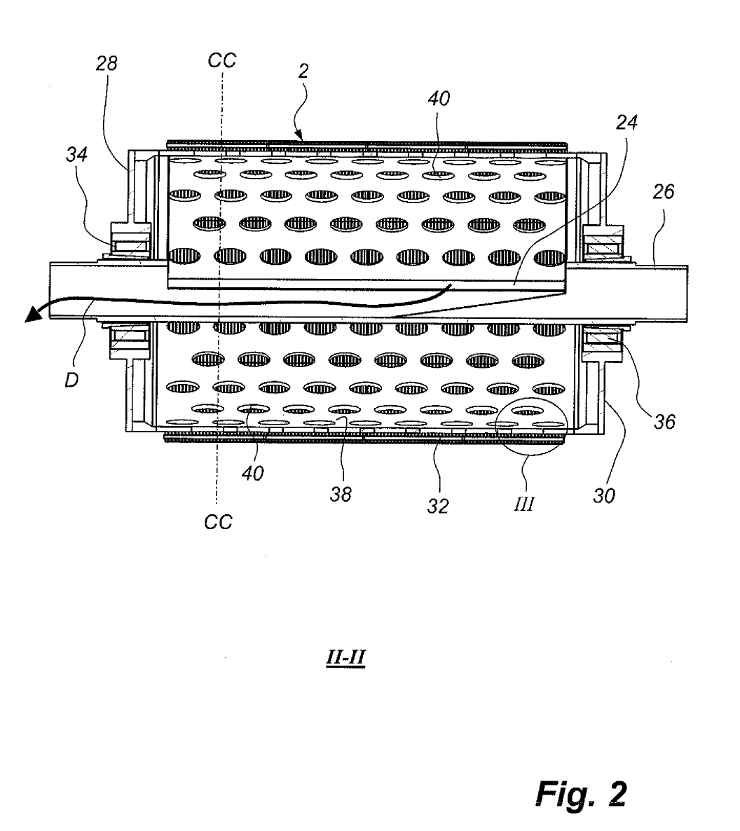

FIG. 2 is a cross-sectional view of the first dewatering drum 2 along the section II-II indicated in FIG. 1. The drum 2 has two end plates 28, 30, which are arranged at either end of the drum's 2 liquid transport layer 32, which will be described in more detail below. Each of the end plates 28, 30 is provided with a first part of a shaft-bearing arrangement in the form of an associated layer 34, 36. Thus, the drum 2 is journalled on the fixed longitudinal shaft 26, as mentioned above, by means of bearing elements in the form of the bearings 34, 36 and is thereby able to rotate about the shaft 26. The wash water collected by the separating wall 24 shown in FIG. 1 is conducted out through the shaft 26, which is hollow, as indicated by an arrow D, and may then be used, for instance, for further washing.

The dewatering drum 2 has a support pipe 38, which has the shape of a cylindrical sleeve attached to the two end plates 28, 30. The support pipe 38 is provided with, in all, about 220 elliptical openings 40, which are substantially evenly distributed across the support pipe 38, as is also indicated in FIG. 1. Through these openings 40, liquid is able to pass into the interior of the drum 2 as liquid is being pressed out of the pulp by the trough 6 shown in FIG. 1, and to leave the interior of the drum 2 at the drainage channel 16 shown in FIG. 1. As appears from FIG. 2, any cross section, taken somewhere along the length of the support pipe 38, will cut through at least one opening 40. In the example shown, where 220 openings 40 are divided into 26 axially extending rows, any such cross section will cut through 13 or 26 openings 40, as seen along the whole circumference of the support pipe 38, see for instance the exemplifying section indication CC, which cuts through an opening 40 in each of said 26 axially oriented rows, as seen along the whole circumference of the support pipe 38. By this, it is to be understood that regardless of which cross section along the length of the support pipe 38 that is considered it will cut through at least one opening 40.

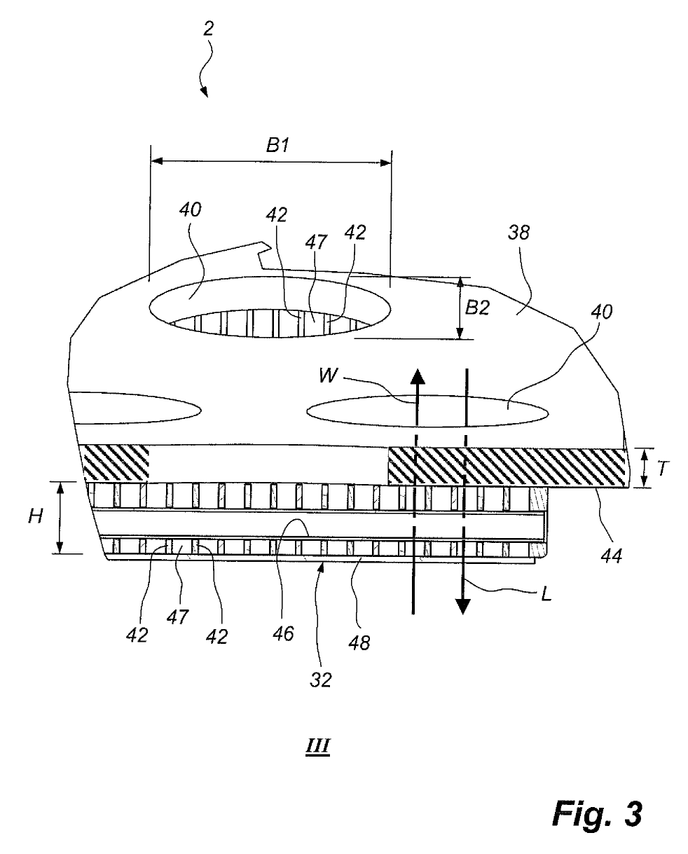

FIG. 3 shows in greater detail the area III shown in FIG. 2 for the purpose of describing the liquid transport layer 32 more exactly. The support pipe 38 is made of a metal, suitably stainless steel, and has a material thickness T, which is suitably about 15-50 mm. Due to the relatively considerable material thickness T, i.e., a thickness of at least 15 mm, the support pipe 38 has great mechanical strength, which means that large forces may be allowed to act on the pulp between the trough 6 and the drum 2. Suitably, each of the elliptical openings 40 has a largest width B1 of about 7-20 cm, and a smallest width B2 of about 5-12 cm. For each of the openings 40, the open area is about 25-200 cm². The total open area of all openings 40 corresponds to about 20% of the total inner lateral area of the support pipe 38, i.e. about 20% of the total inner lateral area is open.

Spacer elements in the form of lamellar rings 42 have been arranged on the outside of the support pipe 38 and extend along the periphery 44 of the support pipe 38. A number of stiffening pipes 46, which extend through the lamellar rings 42 in the axial direction along the support pipe 38, as is also indicated in FIG. 1, are arranged to keep the lamellar rings 42 spaced apart at the desired distance. A liquid-permeable layer in the form of a screen plate 48 has been arranged on the outside of the lamellar rings 42. The lamellar rings 42 suitably has a height H, from the periphery 44 of the support pipe 38, of about 20-70 mm. Between the lamellar rings 42, which each have a material thickness of about 3-7 mm, open ducts 47 are formed which extend substantially along the periphery 44 of the support pipe 38. The width of each such duct 47 is about 10-30 mm. As described above, with reference to FIG. 2, any cross section, taken somewhere along the length of the support pipe 38, will cut through at least one opening 40. This means that each of the ducts 47 will be in contact with at least one opening 40, or more specifically, as illustrated by section CC in FIG. 2, up to 26 openings 40.

When the drum 2 is being used for dewatering of cellulose pulp, water that has been pressed out of the pulp in the gap 7 shown in FIG. 1, will pass through the screen plate 48, continue through the gaps 47 between the lamellar rings 42 and penetrate into the interior of the drum 2 by way of the openings 40 formed in the support pipe 38, as indicated by an arrow W in FIG. 3. The support pipe 38 is without inner structures by which the water tends to be conveyed during rotation of the drum 2, and therefore the liquid will rapidly flow to the bottom of the drum 2, as indicated in FIG. 1. Having accumulated at the bottom of the drum 2, the liquid will rapidly flow out of the drum 2 through the openings 40, the gaps 47 between the lamella 42, and the screen plate 48, as indicated by an arrow L in FIG. 3. Accordingly, due to the design of the dewatering drum 2, liquid that is pressed out of the pulp in the gap 7 rapidly passes into the interior of the drum 2, by way of the openings 40, and liquid that has accumulated at the bottom of the drum 2 then also rapidly flows out of the drum 2 through the same openings 40 and further out through the drainage channel 16 shown in FIG. 1, without being entrained by the drum 2 during rotation thereof.

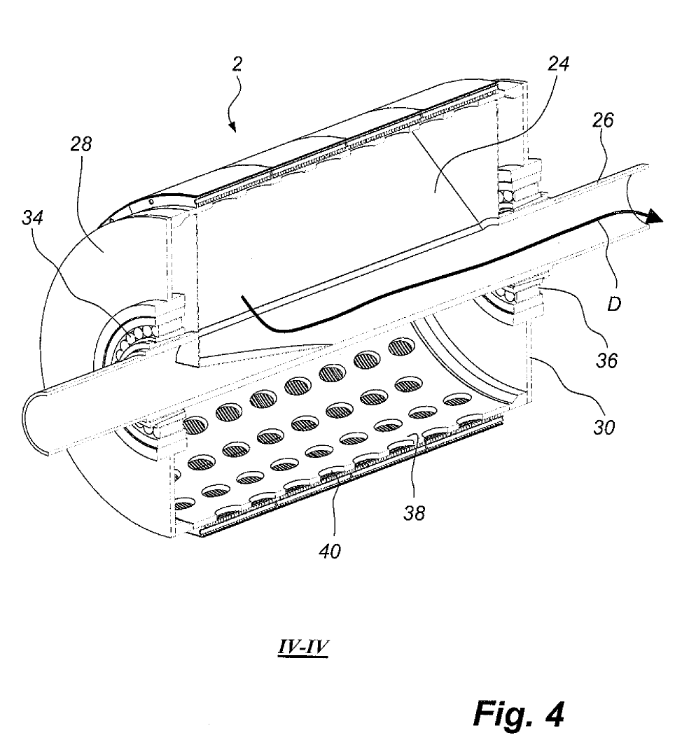

FIG. 4 is a perspective view of the dewatering drum 2 along the cross section IV-IV indicated in FIG. 1. FIG. 4 illustrates how wash liquid collected by the separating wall 24 is conducted to the fixed shaft 26, through which it flows out of the drum 2. Thus, the wash liquid, which is indicated by an arrow D in FIG. 4, passes the drum 2 through the opening in the end plate 30 made to accommodate the bearing 36 and the fixed shaft 26.

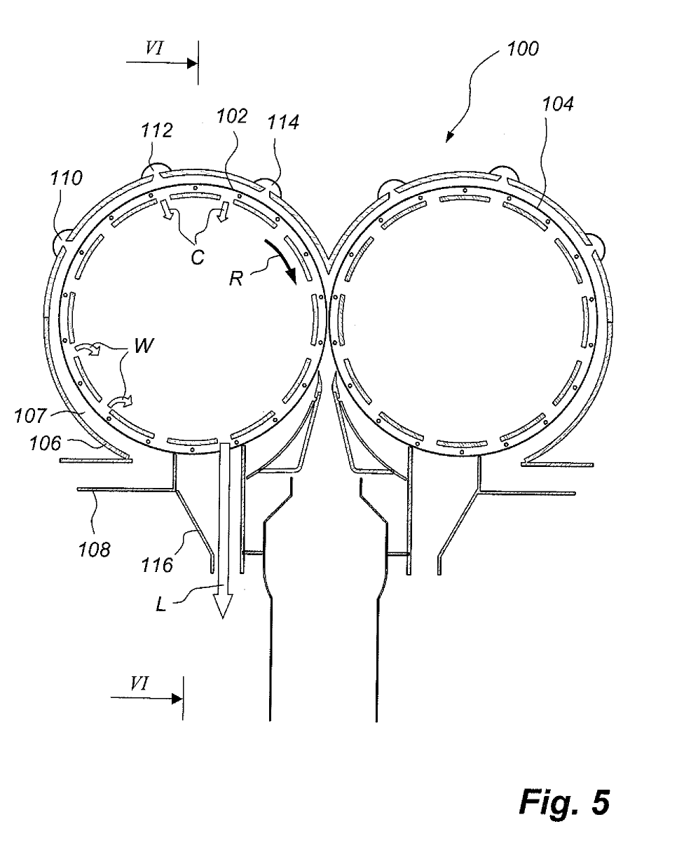

FIG. 5 shows a device 100 for dewatering of cellulose pulp. The device 100 has a first dewatering drum 102 and a second dewatering drum 104. The drum 102 is arranged to rotate clockwise, as indicated by an arrow R in FIG. 5 and the drum 104, which has a design similar to that of the drum 102, is arranged to rotate in the opposite direction, i.e. counter-clockwise. The device 100 further comprises a trough 106 inside which the first dewatering drum 102 is arranged for rotation. At its lower portion, the trough 106 has an inlet 108 for wet cellulose pulp, which can be compressed in the gap 107 formed between the trough 106 and the drum 102. The water contained in the pulp will be pressed through the periphery of the drum 102 and into the interior of the drum 102, as indicated by arrows W in FIG. 5. The main difference between the device 100 and the device 1 shown in FIG. 1 is that the device 100 is completely without the separating walls and the shafts arranged inside the drum that are described in connection with FIG. 1. Thus, wash water, which may be supplied via inlets 110, 112, 114, will pass into the drum 102, as indicated by arrows C in FIG. 5, and mix with the pressed-out water W at the bottom of the drum 102, before flowing out of the drum 102 through a drainage channel 116, as indicated by an arrow L.

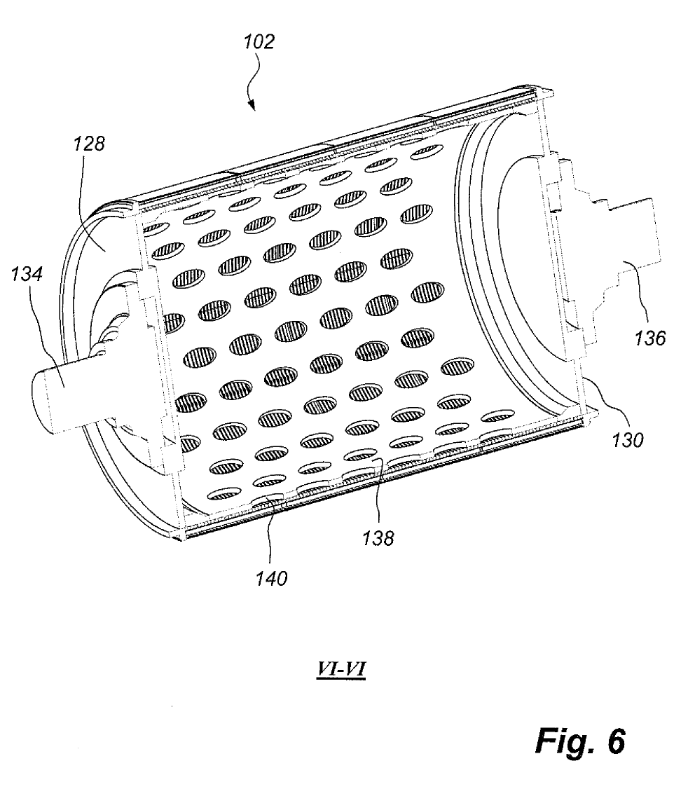

FIG. 6 shows the first dewatering drum 102 as seen along the section VI-VI indicated in FIG. 5. The drum 102 is provided with a support pipe 138, which has substantially the same design as the support pipe 38 described in connection with FIGS. 2-4. The support pipe 138 is attached at its respective ends to end plates 128, 130. Each of the end plates 128, 130 is provided with a first part of a shaft-bearing arrangement in the form of an associated shaft journal 134, 136. Accordingly, as has been mentioned above, the drum 102 is journalled in the device 100, which has bearings that are not shown in FIG. 6, by means of the shaft journals 134, 136 and is, thus, rotatably arranged in the device 100. The support pipe 138 supports lamellar rings and a screen plate in accordance with basically the same principles as those described above in connection with FIG. 3. Water that is pressed out of the pulp in the gap 107, which is shown in FIG. 5, is able, as is wash water, to penetrate into the interior of the drum 102 through openings 140 in the support pipe 138, and to flow out from the interior of the drum 102 through the same openings 140, in accordance with the principles described above in connection with FIG. 3.

The dewatering drum 102 described in FIG. 5 and FIG. 6 is convenient, among other things, in cases where it is not necessary to separate a wash liquid from the other liquid pressed out of the pulp.

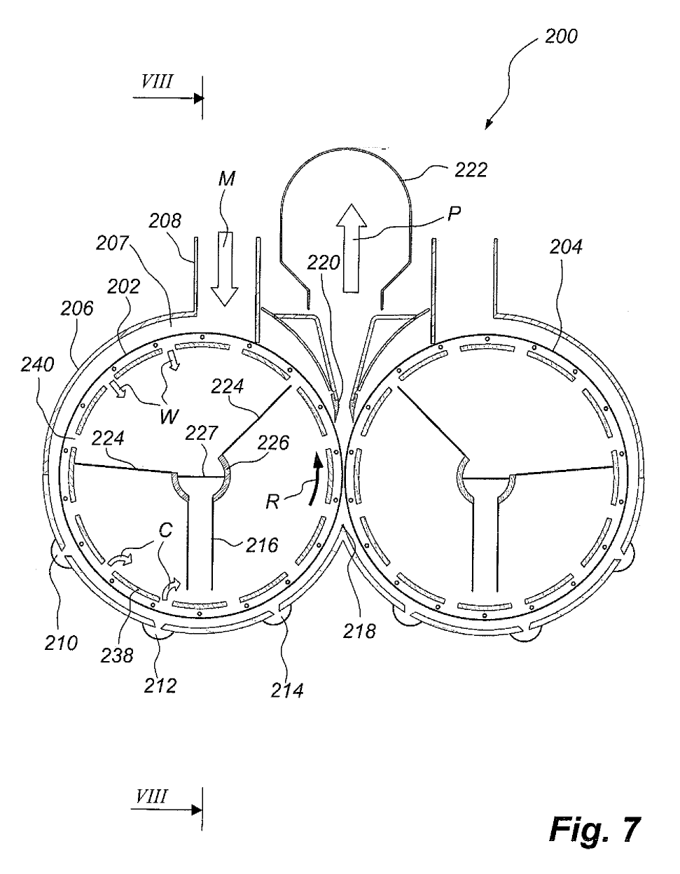

FIG. 7 illustrates, as seen from the side and in cross section, a device 200 for dewatering of wet cellulose pulp. The device 200 has a first dewatering drum 202 and a second dewatering drum 204. The dewatering drum 202 is arranged to rotate counter-clockwise, as indicated by an arrow R in FIG. 7. The dewatering drum 204 is arranged to rotate in the opposite direction, i.e. clockwise, but is, for the rest, similar in parts and function to the first dewatering drum 202, even if the second dewatering drum 204 is mirror-inverted relative to the first dewatering drum 202.

The device 200 further comprises a trough 206 inside which the first dewatering drum 202 is arranged for rotation. At its upper portion the trough 206 has an inlet 208 for wet cellulose pulp. At its lower portion the trough 206 is provided with three liquid inlets 210, 212, 214 for supply of wash water. The trough 206 surrounds the drum 202 along about 240° of the circumference of the drum 202.

During dewatering of pulp the wet pulp is fed to the trough 206 via the inlet 208, as indicated by an arrow M, and is then compressed in the gap 207 formed between the trough 206 and the drum 202. The water contained in the pulp will be pressed through the periphery of the drum 202 and into the interior of the drum 202, as indicated by arrows W in FIG. 7. Inside the drum 202, a separating wall 224 has been arranged which collects the water that has been pressed in. The water collected by the separating wall 224 is then conducted via a fixed longitudinal shaft 226, which also acts as the shaft journal about which the drum 202 rotates, out of the drum 202.

When the pulp has been sufficiently dewatered it is discharged from the trough 206 at the point 218 shown in FIG. 7 and will then be pressed against the pulp that has been dewatered in a corresponding manner on the second dewatering drum 204. A scraper 220 is arranged to scrape off the dewatered cellulose pulp from the drum 202, whereby the dewatered pulp is removed through a conveying pipe 222, which has a conveyor worm (not shown), and leaves the device 200, as indicated by an arrow P.

Wash water, which is supplied via the inlets 210, 212, 214, penetrate into the interior of the drum 202, as indicated by arrows C, and accumulates at the bottom of the drum 202. A drainage channel 216, which has the shape of a substantially vertical pipe, extends from the shaft 226 down to the bottom of the drum 202. The drainage channel 216 is connected to a suction pump (not shown) and is adapted to suck the wash water out of the drum 202 by way of the shaft 226. The shaft 226 is provided with a partition wall 227, which prevents the water collected by the separating wall 224 from mixing with the wash water.

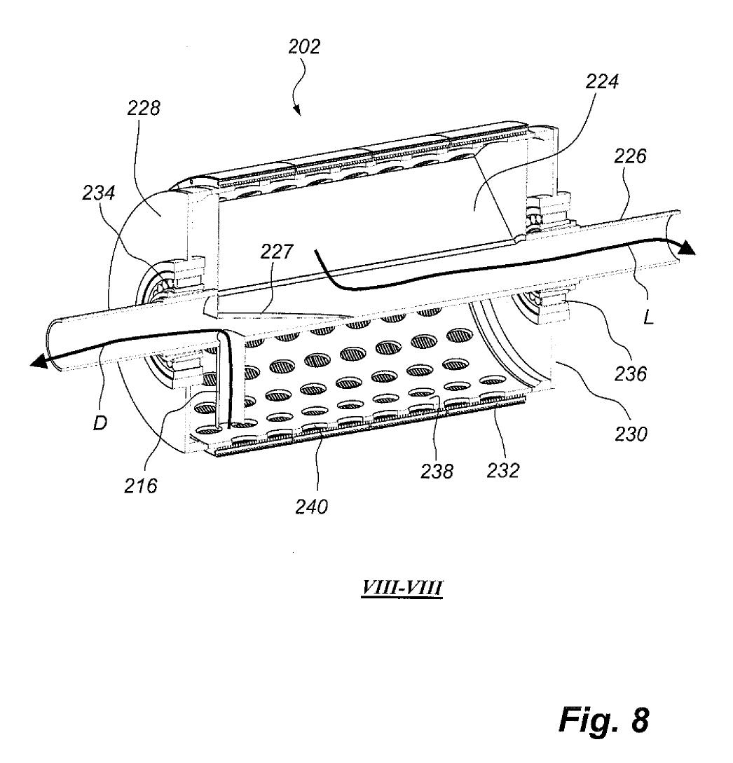

FIG. 8 is a cross-sectional view illustrating the first dewatering drum 202 as seen along the section VIII-VIII indicated in FIG. 7. The drum 202 has two end plates 228, 230, which are arranged at either end of the drum's 202 liquid transport layer 232, which is of the same type as the layer 32 described above in connection with FIGS. 2 and 3. Each of the end plates 228, 230 is provided with a first part of a shaft-bearing arrangement in the form of an associated bearing 234, 236. Thus, the drum 202 is journalled on the fixed longitudinal shaft 226 by means of bearing elements in the form of the bearings 234, 236 and is thereby able to rotate about the latter.

The dewatering drum 202 has a support pipe 238, which has the shape of a cylindrical sleeve attached to the two end plates 228, 230. The support pipe 238 is provided with about 220 openings 240, also shown in FIG. 7, through which openings 240 liquid may pass into the interior of the drum 202, as liquid is being pressed out of the pulp in the trough 206 shown in FIG. 7.

The water collected by the separating wall 224 is conducted out through the shaft 226, as indicated by an arrow L in FIG. 8. The wash water sucked up through the drainage channel 216 is conducted out through the shaft 226, as indicated by an arrow D, and may then be used, for instance, for further washing. As appears from FIG. 8, the partition wall 227 prevents the two liquids from mixing.

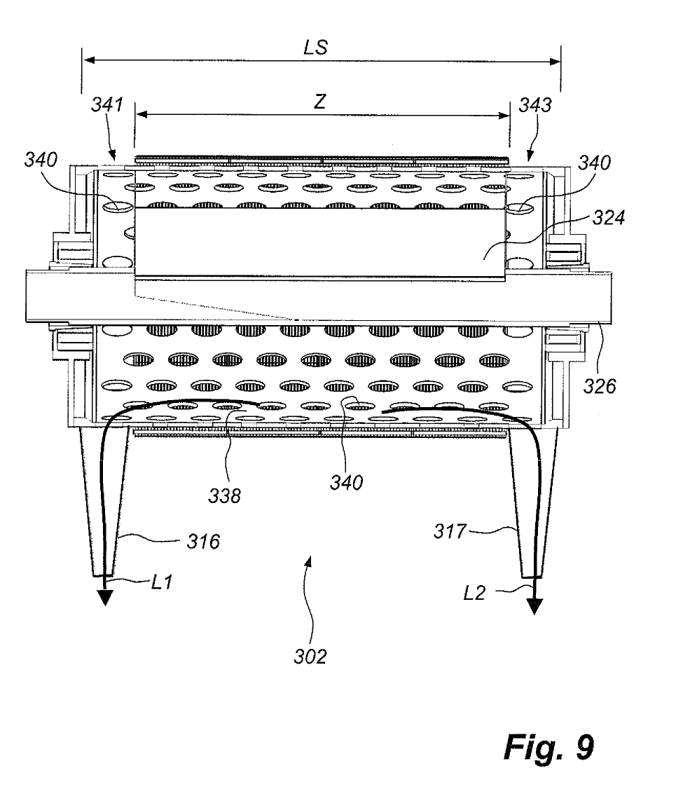

FIG. 9 shows an alternative embodiment in the form of a dewatering drum 302 that may be used in the device 1, but especially in the device 200 described above. The dewatering drum 302 shown in FIG. 9 has a support pipe 338, which is of substantially the same type as the support pipe 238 described above in connection with FIG. 8. However, the support pipe 338 extends, with respect to the length LS of the support pipe, beyond the portion Z of the support pipe 338 that is intended to be covered by a trough, such as the trough 206 shown in FIG. 7. The support pipe 338 is provided with a number of openings 340, whose design is of the same type as the openings 40 described in connection with FIG. 3. As appears from FIG. 9, the support pipe 338 has an outer first row 341 of openings 340, which first row 341 is located in the left end portion of the support pipe 338, as shown in FIG. 9, and an outer second row 343 of openings 340, which second row 343 is located in the right end portion of the support pipe 338. As appears from FIG. 9, the first and second rows 341, 343 are located outside the portion Z intended to be covered by a trough. Thus, no pulp will be pressed against the support pipe 338 in the areas where the first and second rows 341, 343 of openings 340 are located. Therefore, the first and second rows 341, 343 of openings 340 may be used to drain the water that is pressed into the drum 302 in the portion Z. For this purpose, a first drainage channel 316 and a second drainage channel 317 have been provided beneath the drum 302. An arrow L1 indicates how liquid can be drained from the bottom of the drum 302, through openings 340 in the first row 341, and discharged via the first drainage channel 316. An arrow L2 indicates how liquid can be drained from the bottom of the drum 302, through openings 340 in the second row 343, and discharged via the second drainage channel 317. A separating wall 324 may be arranged on a fixed shaft 326, about which the drum 302 is adapted to rotate, for the purpose of separating wash liquid from liquid that has been pressed out of the pulp, in accordance with the principles described above, for example in connection with FIG. 1. Accordingly, when using the drum 302 shown in FIG. 9 it is not necessary to suck out liquid from the drum in the way described in connection with FIG. 8 with respect to the drainage channel 216.

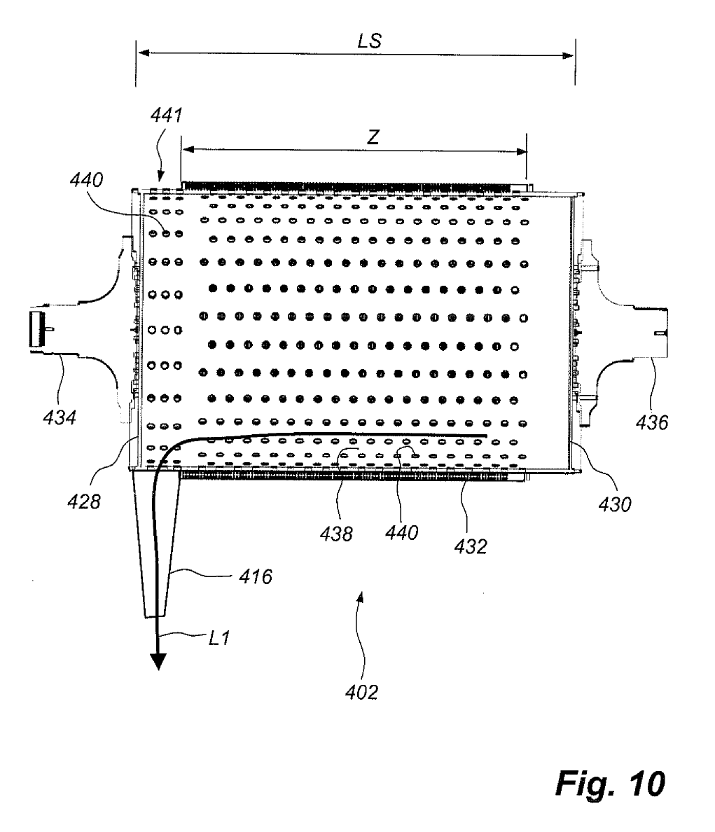

FIG. 10 illustrates an alternative embodiment in the form of a dewatering drum 402 that may be used in the devices 1, 100 or 200 described above. The dewatering drum 402 shown in FIG. 10 has a support pipe 438, which is made from stainless steel and is of substantially the same type as the support pipe 338 described above in connection with FIG. 9, and which extends, with respect to the length LS of the support pipe 438, beyond a portion Z of the support pipe 438 that is intended to be covered by a trough, such as the trough 206 shown in FIG. 7. The support pipe 438 is attached at its respective ends to end plates 428, 430, each of which is provided with a first part of a shaft-bearing arrangement in the form of an associated shaft journal 434, 436, similar to those illustrated in FIG. 6. Accordingly, the drum 402 may be journalled in the device 1, 100 or 200, being provided with suitable bearings, and may, thus, be rotatably arranged in the device 1, 100 or 200. The support pipe 438 is provided with a number of openings 440. Typically, the openings 440 may be circular holes, each such hole having a diameter of 14 mm. As appears from FIG. 10, the support pipe 438 has an outer row 441 of openings 440, which outer row 441 is located in the left end portion of the support pipe 438, as shown in FIG. 10, and is located outside the portion Z intended to be covered by a trough. Thus, no pulp will be pressed against the support pipe 438 in the area where the outer row 441 of openings 440 is located, such that the outer row 441 of openings 440 may be used to drain the water that is pressed into the drum 402 in the portion Z. An arrow L1 indicates how liquid can be drained from the bottom of the drum 402, through openings 440 in the outer row 441, and discharged via a first drainage channel 416. The drum 402 has a liquid transport layer 432, which is of the same type as the layer 32 described above in connection with FIGS. 2 and 3. The material thickness T of the support pipe 438 is about 20 mm. The length LS of the support pipe 438 is about 2.6 m. It will be appreciated that the design illustrated in FIG. 10 could also be modified to support pipes being shorter or longer than 2.6 m. For longer support pipes, such as support pipes having a length LS of 4 m and more, the material thickness T is higher, such as up to 50 mm, or even up to 70 mm. For longer support pipes it is also possible to utilize double drainage channels, in a similar manner as illustrated in FIG. 9.

It will be appreciated that many variants of the embodiments described above are conceivable within the scope defined by the appended claims.

A device 1, 100, 200 has been described above which is provided with two dewatering drums, see for example the dewatering drums 2, 4 in FIG. 1. It is also possible to design a device with only one dewatering drum, in which case dewatering of the pulp occurs mainly against a trough. In the case where only one dewatering drum is provided, external rolls, which compress the pulp against the drum, may be used.

It has been described above how the support pipe 38 is provided with 220 openings 40, which are elliptical in shape. It will be appreciated that differently shaped openings, such as circular, square, triangular, etc may also be used. Furthermore, the number of openings 40 in the support pipe 38 may be varied depending on their size and the amount of water that is to be allowed to penetrate. Suitably, at least ten openings 40 are used, preferably at least 50 openings 40, which conveniently are substantially evenly distributed along the periphery 44 of the support pipe 38.

Suitably, each opening 40 has an open area that corresponds to about 1-200 cm², even more preferred 1.5-100 cm². A smaller open area increases the risk of fibres clogging the opening 40 and of water not being able to pass through the opening 40 as rapidly as desired. An excessively large open area for each opening 40 reduces the mechanical strength of the support pipe 38. In the case of elliptical openings 40, for example of the type described in FIG. 3, the open area of each such elliptical opening 40 is suitably 25-200 cm². In the case of openings 40 having the shape of circular holes, which may conveniently be formed by drilling, a hole diameter of about 12-70 mm is appropriate, even more preferred about 14-50 mm, which corresponds to an open area for each such circular opening of about 1-40 cm², even more preferred about 1.5-20 cm². In the cases where the openings 40 in the support pipe 38 are relatively small circular holes, for example with a diameter of about 12-18 mm, it may sometimes be convenient to position such holes at the centre of the gaps 47 formed between the lamella 42 according to FIG. 3, i.e. such that the lamella 42 do not cover any appreciable part of these relatively small, circular holes.

To allow rapid transport of liquid through the openings 40 in the support pipe 38 and, where appropriate, to allow rapid transport of liquid out through the openings 40, as illustrated, for instance, in FIG. 3, the total open area representing the aggregate area of all openings 40 in the support pipe 38 should be relatively large. This means that the total open area should be at least 10% of the inner lateral area of the support pipe 38. If the support pipe 38, for example, has an inner diameter of 1 metre and a length of 3 metres, its inner lateral area is: 3.14*1 m*3 m=9.4 m². In this case, the total area of all openings 40 should not be less than 0.94 m². Considering the strength of the support pipe 38, the total area of all openings 40 should not exceed 40% of the inner lateral area, i.e. the total area of all openings 40 should not exceed 3.8 m². In the case where each opening is elliptical and has the dimensions B1=14 cm, B2=7 cm, according to FIG. 3, each such opening has an open area of 77 cm². If a total open area representing 20% of the inner lateral area of the support pipe 38 is desired, which in the examples above correspond to a total open area of 1.88 m², it follows that 1.88 m²/77 cm² per hole=244 holes are required. If each opening is instead circular and has a diameter of 16 mm, i.e. has an open area per opening of 2 cm², the number of holes required is instead 1.88 m²/2 cm²=9400 holes.

In the above description, the spacer elements consist of lamellar rings. It will be appreciated that also other types of spacer elements may be used to position the liquid-permeable layer at a distance from the support pipe and to form ducts in which liquid may be conducted from the screen plate to the openings formed in the support pipe.

As mentioned hereinbefore, the material thickness T of the support pipe 38, 138, 238, 338, 438 is at least 15 mm, and may be up to 70 mm. Often the material thickness T of the support pipe is in the range of 15-50 mm.

In the above description, the liquid-permeable layer consists of a screen plate. A plate of this kind may be a metallic plate having a large number of small holes, each typically with a diameter from 0.5 to 1.5 mm. Also other types of liquid-permeable layers may be used, for example filter nets, wirecloth, etc.

1. A dewatering drum for dewatering of cellulose pulp, said dewatering drum comprising:
a plurality of end plates each arranged at an end of the dewatering drum, an outer periphery of the dewatering drum having a liquid-permeable layer, against which cellulose pulp is to be compressed for dewatering the pulp,
each of the plurality of end plates having a central portion supporting a first part of a shaft-bearing arrangement,
a support pipe including a cylindrical sleeve having a material thickness (T) in a range of 15 millimeters (mm) to 70 mm, and having ends connected to the end plates,
said liquid-permeable layer being arranged proximate to an outer periphery of the support pipe and held in position at a distance from the outer periphery of the support pipe by means of spacer elements,
at least ten openings in the outer periphery of the support pipe through which flows liquid that passes through the liquid-permeable layer to an interior of the support pipe.

2. A dewatering drum as claimed in claim 1, wherein the support pipe has at least one drain opening from which flows liquid from the interior of the support pipe.

3. A dewatering drum as claimed in claim 2, wherein the dewatering drum has a portion (Z) of a length arranged to receive compressed cellulose pulp, at least one of said drain openings being axially outside said portion (Z).

4. A dewatering drum as claimed in claim 1, wherein the support pipe is substantially without inner structures.

5. A dewatering drum as claimed in claim 1, wherein the end plates are each provided with a shaft journal, which forms said first part of the shaft-bearing arrangement.

6. A dewatering drum as claimed in claim 1, wherein the end plates are each provided with a bearing, which forms said first part of the shaft-bearing arrangement.

7. A dewatering drum as claimed in claim 1, wherein the dewatering drum is arranged to rotate about a central shaft.

8. A dewatering drum as claimed in claim 7, wherein the central shaft supports a separating wall, which is arranged to collect liquid that is pressed into the dewatering drum.

9. A dewatering drum as claimed in claim 8, wherein the separating wall extends from the shaft towards the support pipe, the shaft being arranged to receive liquid that has penetrated through said at least ten openings in the support pipe and to conduct the liquid out of the support pipe via said bearing.

10. A dewatering drum as claimed in claim 5, wherein a duct, which is arranged to suck out liquid that has penetrated into the interior of the support pipe, extends into the support pipe via said bearing.

11. A dewatering drum as claimed in claim 1, wherein the support pipe is made of metal and has a material thickness (T) in a range of 15-50 mm.

12. A dewatering drum as claimed in claim 1, wherein each of said at least ten openings in the support pipe has an open area in a range of 1-200 centimeters squared (cm2).

13. A dewatering drum as claimed in claim 1, wherein the total open area of all openings in the support pipe corresponds to at least 10% of the inner lateral area of the support pipe.

14. A dewatering drum as claimed in claim 1, wherein said spacer element is formed of lamellar rings which extend around the drum and are supported by the support pipe.

15. A dewatering drum for dewatering of cellulose pulp, said dewatering drum comprising:
end plates each arranged at an end of the dewatering drum, each end plate includes a central portion coupled to a central shaft via a shaft-bearing arrangement;
a support pipe having a cylindrical sleeve with a material thickness (T) in a range of 15 millimeters (mm) to 70 mm, wherein each end of the support pipe is connected respectively to a peripheral edge of one of the end plates;
a liquid-permeable layer forming a sleeve around a cylindrical surface of the support pipe, wherein the liquid-permeable layer is adapted to receive a layer of cellulose pulp to be compressed for dewatering the pulp;
a spacer assembly positioning the liquid-permeable layer radially outward the cylindrical surface of the support pipe, and
a plurality of at least ten apertures in the cylindrical surface of the support pipe through which flow liquid from the liquid-permeable layer to an interior chamber of the support pipe.

16. The dewatering drum as in claim 15 further comprising at least one drain aperture in the support pipe to drain liquid from the interior chamber, wherein the drain aperture is axially beyond a region of the cylindrical surface of the support pipe enclosed by the sleeve formed by the liquid-permeable layer.

17. The dewatering drum as in claim 15 wherein the interior chamber of the support pipe is between the end plates and is devoid of an inner support structure.

18. A dewatering drum as in claim 15 further comprising a separating wall in the interior chamber and supported by the central shaft which extends through the interior chamber.

19. A dewatering drum as in claim 18 wherein the separating wall extends through the interior chamber from the central shaft radially outwards towards the support pipe.

20. A dewatering drum as claimed in claim 15 wherein the support pipe is made of metal and has a material thickness (T) in a range of 15-50 mm.
